(19) United States
(12) Patent Application Publication
(10) Pub. No.: US 2003/0217185 A1
(43) Pub. Date: Nov. 20, 2003

(54) Method and apparatus for reducing interrupts in a high-speed ethernet media access controller (MAC) by interrupt canceling

(76) Inventors: Anshuman Thakur, Beaverton, OR (US); Frank C. Verhoorn III, Beaverton, OR (US)

Correspondence Address: Pillsbury Winthrop LLP, Intellectual Property Group, Suite 2800, 725 South Figueroa Street, Los Angeles, CA, 90017-5406, US

(21) Appl. No.: 10/113,477

(22) Filed: Mar. 29, 2002

(51) Int. Cl. G06F 15/16

(52) U.S. Cl. 709/250; 710/261

(57) ABSTRACT

A system to accumulate routine and critical interrupt-triggering events, and generate an interrupt. A network communicates data. A computing device executes an operating system. A Network Interface Card (NIC) communicates data with the network and with the operating system, and invokes an interrupt. The NIC accumulates routine interrupt-triggering events and includes a timer to limit a length of time during which routine interrupt-triggering events accumulate, and if a critical interrupt-triggering event is received or the timer expires, the interrupt is invoked and the timer is reset. A driver provides an interface between the operating system and the NIC.

### BACKGROUND OF THE INVENTION

1. Field of the Invention

This invention relates to the field of interrupt processing, and more specifically, to a system, method, and apparatus for using interrupt canceling to reduce the amount of interrupts processed by a computing device.

2. Background of the Invention

High-speed networks communicate data through the use of Network Interface Cards (NICs). Each NIC is often coupled to a computer having its own operating system. Typical operating systems include Windows and Linux. The operating system is used to send packets from the computer to the NIC, and then from the NIC over to another NIC on the network. The computer's operating system is also utilized to receive packets from the NIC.

The operating system includes a driver, or a piece of software, that provides an interface between the operating system and the NIC. For proper functioning of the NIC, the driver requires the NIC to notify it regarding various routine hardware events such as receiving a packet, etc., as well as various critical hardware events. Intelligent scheduling of such events/interrupts is critical to system performance. Events such as the hardware running out of work to do, or hardware detecting a cable getting disconnected are a few examples of such critical hardware events. A NIC typically has around a few dozen of such events defined.

Software can enable or disable any event reporting. Invocation of an interrupt causes the operating system to stop its normal task and transfer control to an Interrupt Service Routine (ISR). The ISR is a software module invoked when an interrupt is generated. Upon execution, the ISR determines the cause of the interrupt and takes appropriate action to service the hardware request.

The NICs typically communicate with the driver only through system interrupts. Although interrupts are necessary, they have a severe impact on the performance of the system. To improve the overall performance, current systems attempt to minimize the number of interrupts generated by the NIC and maximize the amount of work done by the driver during each interrupt-triggering event. In a system with active network traffic, packet reception by the NIC is one of the major contributors to interrupt generation. To minimize the number of interrupts generated on packet reception, the hardware provides a configurable timer and delays an interrupt trigger to accumulate multiple events before asserting the interrupts. The driver for the hardware does its part by servicing all work that has accumulated (both the status for transmits and processing packets received) in the interrupt servicing routine. However, if a critical event occurs (such as the hardware running out of work to do, for example), an interrupt must be invoked immediately to service the critical event. Systems in the art then service the critical event and the accumulated events. After servicing is complete, normal processing resumes. However, current systems do not reset the timer. Accordingly, once the timer expires there often are no, or very few, events to service (because the accumulated events were already serviced during the invocation of the interrupt upon the occurrence of the critical event). Accordingly, the invocation of the interrupt upon expiration of the timer can be inefficient.

High-speed networks in the art are therefore deficient because interrupts are frequently invoked upon the expiration of a timer utilized to accumulate interrupt-generating events for servicing upon generation of an interrupt because such timers are not reset upon the invocation of an interrupt due to a critical event. Such systems therefore often invoke interrupts even though no event needs to be serviced, resulting in sub-optimal system performance.

### BRIEF DESCRIPTION OF THE DRAWINGS

FIG. 1 illustrates a block diagram of a high-speed network utilizing the interrupt servicing and canceling system according to an embodiment of the invention;

FIG. 2 illustrates a process utilized to register and invoke an interrupt service routine according to an embodiment of the invention;

FIG. 3 illustrates a process utilized to accumulate interrupt triggering events and reset an interrupt accumulating timer after invocation of an interrupt according to an embodiment of the invention;

FIG. 4 illustrates a process utilized to accumulate interrupt triggering events and reset an interrupt accumulating timer after (a) receiving each interrupt triggering event or (b) invocation of an interrupt according to an embodiment of the invention;

FIG. 5 illustrates a process utilized to enable interrupts at system boot-up according to an embodiment of the invention; and

FIG. 6A illustrates an interrupt triggering event being accumulated and serviced after a preset length of time according to an embodiment of the invention;

FIG. 6B illustrates multiple interrupt triggering actions being accumulated and serviced after a preset length of time after the first interrupt triggering event occurs according to an embodiment of the invention;

FIG. 6C illustrates multiple interrupt triggering actions being accumulated and serviced after a critical interrupt triggering event occurs according to an embodiment of the invention; and

FIG. 6D illustrates multiple interrupt actions being accumulated and serviced after a preset length of time after the last interrupt triggering event occurs according to an embodiment of the invention.

### DETAILED DESCRIPTION

An embodiment of the present invention may maximize computer system performance during interrupt processing of a high-speed network by resetting a timer utilized to allow interrupt triggering events to accumulate for a preset length of time after an interrupt has been generated in response to a critical interrupt-triggering event. The embodiment accumulates interrupt triggering events and may generate interrupts and reset the timer upon (a) the expiration of the timer utilized to allow interrupt-servicing actions to accumulate for a predetermined length of timer, or (b) the occurrence of a critical event. Hardware running out of work to door or the hardware detecting a cable getting disconnected are examples of such critical hardware events. Upon the invocation of an interrupt, the timer may be reset. Accordingly, system performance may improve because the timer is reset, preventing the invocation of an interrupt due to timer expiration immediately after servicing an interrupt caused by a critical event.

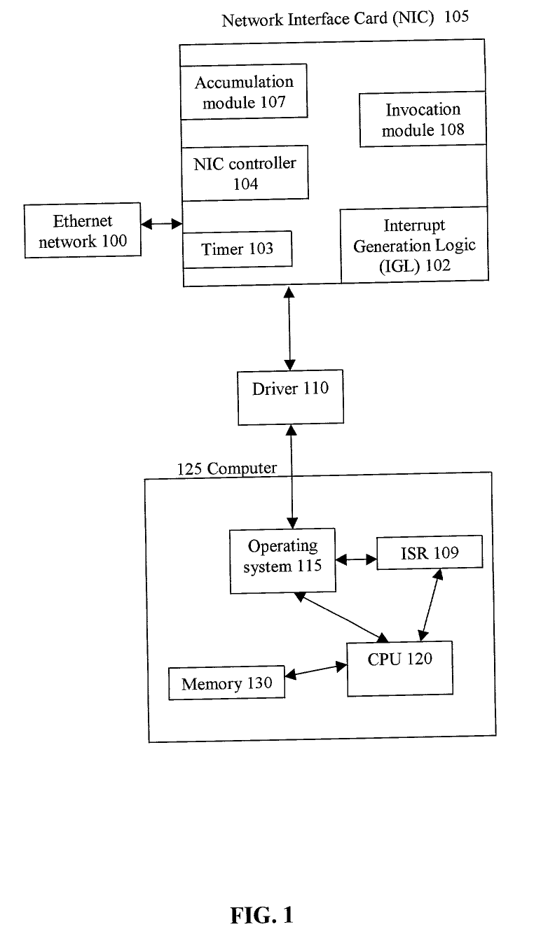

FIG. 1 illustrates a block diagram of a high-speed network utilizing the interrupt servicing and canceling system according to an embodiment of the invention. The system may include a network such as Ethernet network 100, a Network Interface Card (NIC) 105, a driver 110, and a computer 125 having an operating system 115. The NIC 105 may be coupled to the Ethernet network 100 and to the driver 110. The driver 110 may be used to interface with the operating system 115. In an embodiment of the invention, the driver 110 may be part of the operating system 115 In other embodiments, the driver 110 may be separate from the operating system 115.

The Ethernet network 100 may be a high-speed network such as a “10” gigabit or a “1” gigabit network or a network of any suitable bandwidth, for example. In other embodiments, a network other than an Ethernet network 100 may also be utilized. The NIC 105 may include a Media Access Controller (MAC). The MAC is the part of the NIC 105 that contains all of the digital logic for the NIC 105. The NIC 105 may also include a physical layer (PHY). The PHY may be utilized to translate an electrical signal so the signal can be transmitted on a copper or fiber wire.

The driver 110 may be utilized to couple the operating system 115 to the NIC 105. The operating system 115 may be executed by a Central Processing Unit (CPU) 120 in the computer 125. In other embodiments, any suitable computing device other than computer 125 may be used, for example. The operating system 115 is the master control program that runs the computer 125. The first program loaded when the computer 125 is turned on, its main part, the “kernel,” resides in memory at all times. The operating system 115 sets the standards for all application programs that are executed by the computer 125. The applications “talk to” the operating system 115 for all user interface and file management operations. Also called an “executive” or “supervisor,” the operating system 115 may perform any of the following functions: (a) user interface, (b) job management, (c) task management, (d) data management, (e) device management, and (f) security.

The device management functionality of the operating system 115 controls peripheral devices by sending them commands in their own proprietary language. The software routine that deals with each device is the driver 110. The operating system 115 contains all drivers for peripherals attached to the computer 125. When a new peripheral is added, that device's driver is installed into the operating system 115.

The driver 110 provides an interface between the operating system 115 and the NIC 105, or other hardware. The driver 110 may be utilized to harness the capability of the NIC 105, which may be a gigabit Ethernet NIC, and enable seamless operation with the operating system 115.

For proper functioning of the NIC 105, the driver 110 requires that the NIC 105 notify it regarding routine and critical hardware events. Sometimes the notification is required to achieve higher performance. Receiving a full packet off the Ethernet network 100 is an example of a routine hardware event. Routine hardware events need not be serviced right away. Events such as the NIC 105 running out of work to do or detecting a cable getting disconnected are examples of critical hardware events. Critical hardware events must be serviced right away. Software can enable or disable any event reporting. Invocation of an interrupt causes the operating system 115 to stop executing its normal task and transfer control to an “interrupt service routine” executed by the CPU 120.

The NIC 105 communicates with the driver 110 via system interrupts. Interrupt generation logic 102 on the NIC 105 provides a number of events on which the system interrupt signal may be asserted. When the system is booted (i.e., the operating system 115 is loaded and the NIC 105 is initialized), the driver 110 configures the interrupt generation logic 102 on the NIC 105 by enabling the events on which the driver 110 requires notification via the interrupts. Two frequent events on which the driver 110 would require notification include: (a) notification upon packet reception (i.e., when a packet of data is received by the NIC 105) and (b) notification upon packet transmission (i.e., when a packet has been transmitted by the NIC 105). When hardware is running low on structures such as memory buffers or commands, the NIC 105 may also notify the driver 105 via an interrupt. Also, the availability of a new status (e.g., a link coming back up or speed changing on the line from 1 Gbps to 100 Mbps) may be communicated by an interrupt.

Interrupts are necessary to transfer data between the NIC 105 and the driver 110. The NIC's 105 primary function is to provide an interface between the operating system 115 and the Ethernet network 100. The NIC 105 implements this functionality by transferring packets of data from the operating system 115 out onto the network 100, and by receiving packets of data from the network 100 and transferring the packets to the memory 130 of the computer 125. However, the NIC 105 must also notify the driver 110 of this transfer, as discussed above. In order to notify the driver 110 of its action, the NIC 105 may invoke an interrupt to the operating system 115 that signals the operating system 115 to halt its current stream of tasks and start execution of the Interrupt Service Routine (ISR) 109 associated with the NIC 105. The ISR 109 may be implemented by a software module, for example. The ISR 109 then checks the computer's 125 memory 130 for data and status associated with the packets transferred. An embodiment of the invention may be directed to maximizing the amount of actions undertaken during an interrupt invoked by the NIC 110, and reducing the amount of interrupts invoked, resulting in improved system performance.

The NIC 105 may include a NIC controller 104 to control a timer 103. The timer 103 may be utilized to allow interrupt triggering events to accumulate for a predetermined length of time. Upon expiration of the timer 103 (e.g., counting down to “0”), an interrupt may be invoked and the accumulated interrupt-triggering events may be serviced. If a critical interrupt-triggering event occurs during the accumulation process, an interrupt may be invoked immediately, regardless of the timer value, and the timer 103 may be reset so that is does not trigger an interrupt later. The critical event and the accumulated events may then be serviced. The NIC 105 may include an accumulation module 107 to accumulate the interrupt-triggering events, and an invocation module 108 to invoke the interrupts.

Although the computer 125 is shown only as housing the operating system 115 and the CPU 120, other embodiments may include the driver 110 and the NIC 105 within the computer 125. Code for the operating system 115, the ISR 109, and the driver 110 may be stored within a memory 130 such as a hard drive or a RAM, for example. The code may then be executed by the CPU 120.

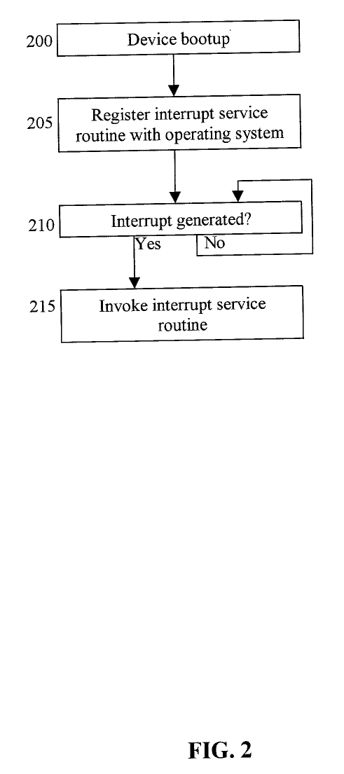

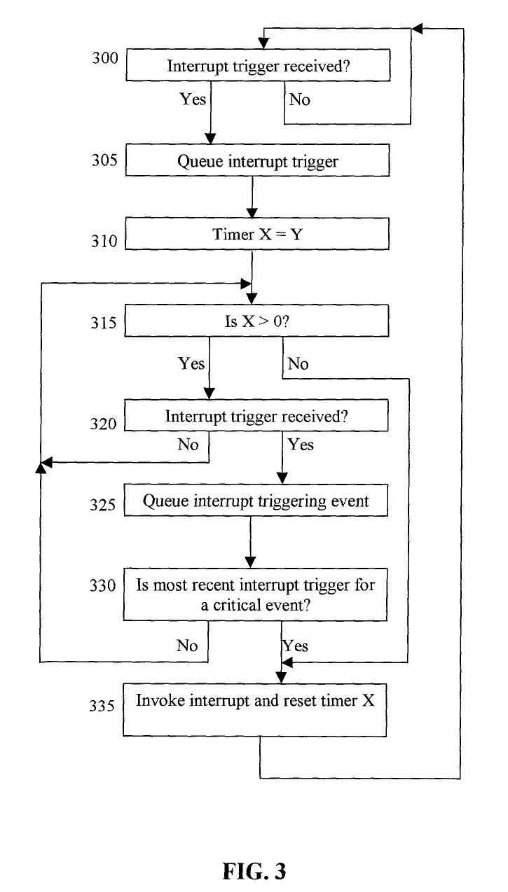

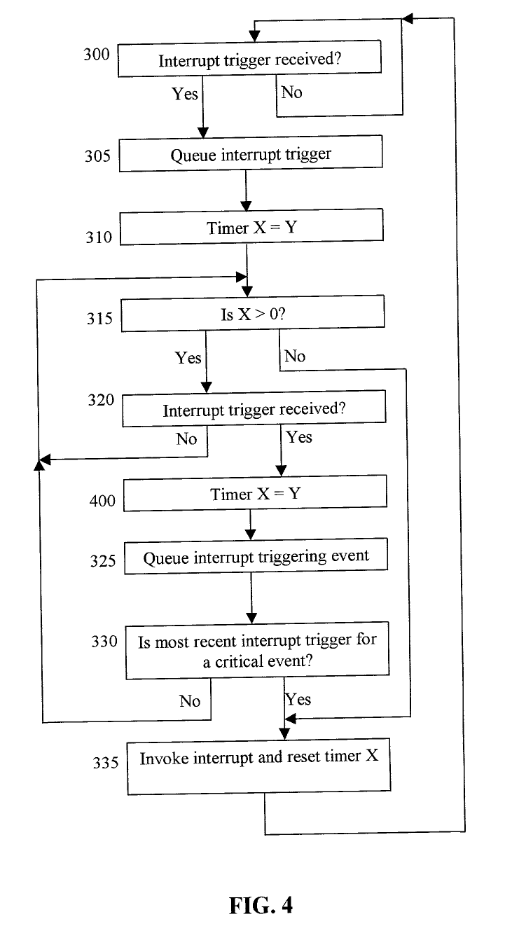

FIG. 2 illustrates a process utilized to register and invoke an Interrupt Service Routine (ISR) 109 according to an embodiment of the invention. When the system is initially booted 200 (i.e., the operating system 115 is loaded and the NIC 105 is initialized), the driver 110 registers 205 the ISR 109 with the operating system 115. The ISR 109 is a software module that is invoked when an interrupt is generated. When the operating system 115 observes an interrupt assertion, the ISR 109 is executed. The ISR 109 generally prioritizes and services interrupt-triggering tasks. After registering 205 the ISR 109, the processing waits 210 for an interrupt to be generated. If an interrupt has not been generated, the processing remains at step 210 until one is generated. Upon the generation of an interrupt, the interrupt service routine is invoked 215, as discussed below with respect to FIGS. 3 and 4.

FIG. 3 illustrates a process utilized to accumulate interrupt triggering events and reset an interrupt accumulating timer after invocation of an interrupt according to an embodiment of the invention. First, the process determines 300 whether an interrupt triggering event has been received. If such a trigger has not been received, processing remains at step 300. However, if a triggering event is received, then the interrupt triggering event is queued 305, and timer “X” is initialized 310 with the value “Y,” which may be a measurement of time such as “10 microseconds,” for example. Timer X may be utilized to limit the amount of time during which interrupt-triggering events may accumulate, and which may then be serviced during an interrupt.

Next, the process determines 315 whether timer X has a value that is greater than “0.” If “yes,” then time remains to accumulate additional interrupt-triggering events. If timer X is greater than “0,” processing continues to step 320; otherwise, processing proceeds to step 335. At step 320, the system determines whether another interrupt triggering event has been received. If “yes,” processing continues to step 325, where the interrupt triggering event is queued 325. If “no,” processing returns to step 315. After step 325, the system determines 330 whether the most recent interrupt triggering event was a critical event. If “yes,” an interrupt may be invoked and the timer 103 reset 335, and processing returns to step 300. If “no,” then processing returns to step 315, and more interrupt triggering events may be accumulated. When an interrupt is invoked, the ISR 109 may service the accumulated interrupt triggering events.

Accordingly, the method shown in FIG. 3 is utilized to accumulate interrupt-triggering events for an amount of time equal to Y (this is the value to which timer X is initialized at step 310) after the first interrupt-triggering event is received. After the timer X expires (e.g., counts down to “0”), the accumulated interrupt-triggering events may be serviced. However, if a critical interrupt-triggering event occurs during the accumulation process, the critical interrupt-triggering event and all other accumulated interrupt-triggering events are serviced, and the process repeats. Once the next interrupt-triggering event occurs, the timer X is again initialized 310 to the value “Y.” The resetting of timer X after invoking an interrupt due to a critical interrupt-triggering event may result in more events being serviced during each interrupt, as well as fewer total interrupts being invoked. Therefore, since the process may reduce the total amount of interrupts processed, it is said to result in the “canceling” of interrupts.

FIG. 4 illustrates a process utilized to accumulate interrupt triggering events and reset an interrupt accumulating timer after (a) receiving each interrupt triggering event or (b) invocation of an interrupt according to an embodiment of the invention. The process shown in FIG. 4 is very similar to that shown in FIG. 3. As shown, the method of FIG. 4 performs all of the same actions (i.e., steps 300-335) as the method shown in FIG. 3. However, FIG. 4 contains an additional step 400 to reinitialize timer X to the value Y after an interrupt-triggering event other than the first interrupt triggering event received at step 300 is detected. In other words, when the process begins, a interrupt triggering event may be received 300, queued 305, and the timer X may be initialized 310 to the value Y. Then the processing may accumulate additional interrupt-triggering events until the timer X counts down to “0.” However, if an additional interrupt-triggering event is received 320, the timer X is re-initialized 400 to the value “Y” and additional interrupts may be queued until timer X counts down to “0.” Accordingly, the accumulated interrupts may be serviced after (a) a critical interrupt-triggering event is received, or (b) a length of time equal to “Y” occurs without any interrupt-triggering events being received after the last interrupt-triggering event was received. Therefore, additional interrupts can be received and processed during an invocation of an interrupt, resulting in improved system performance.

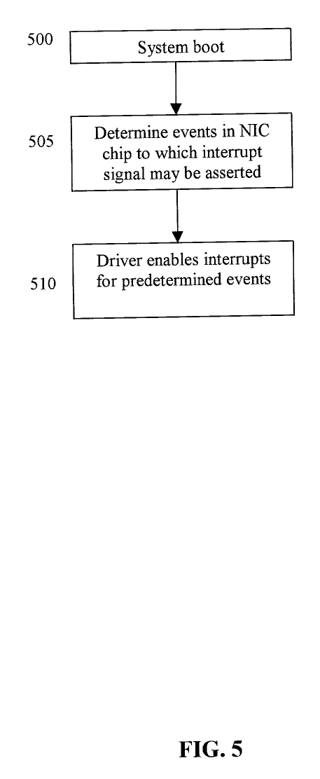

FIG. 5 illustrates a process utilized to enable interrupts at system boot-up according to an embodiment of the invention. First, the system boots 500. Next, the system determines 505 upon which events an interrupt signal may be asserted. The NIC 105 may contain a list of events upon which an interrupt signal may be invoked, and the driver 110 accesses this listing, and then enables 510 interrupts in the NIC 105 for certain predetermined events. In an embodiment, all of the events contained in the listing may enabled by the driver 110. In other embodiments, only some of the events may be enabled by the driver 110.

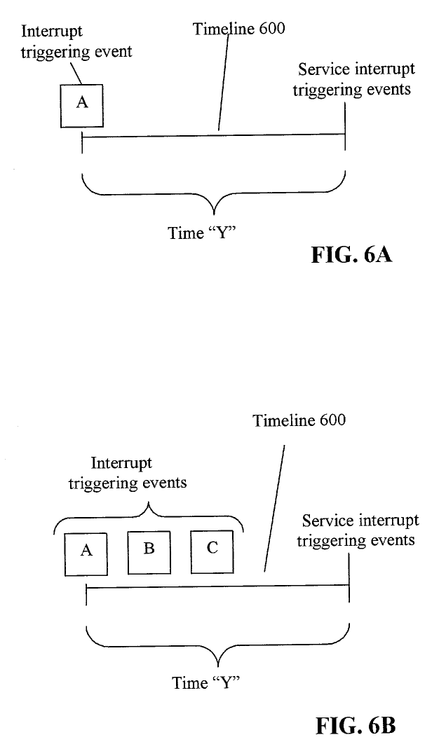

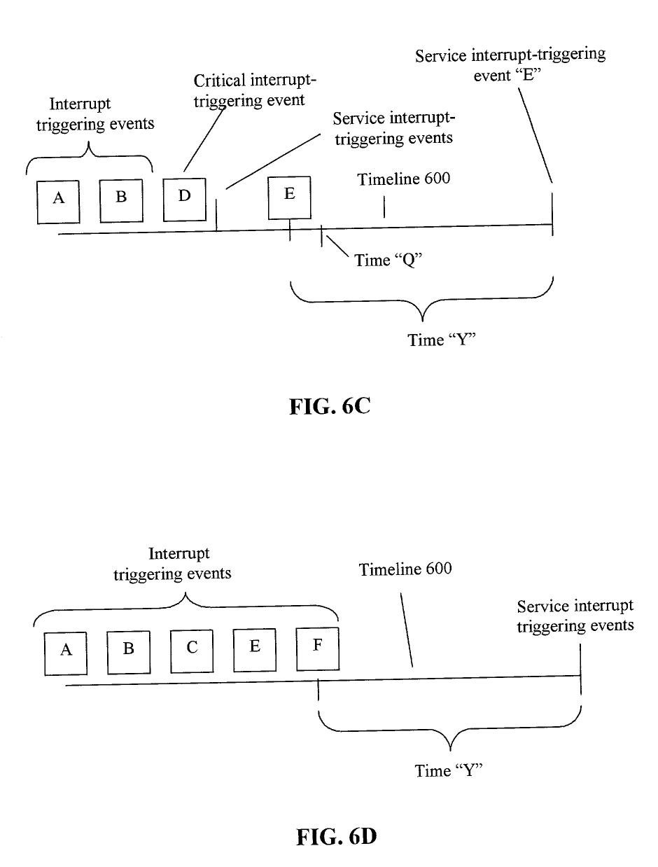

FIG. 6A illustrates an interrupt triggering event being accumulated and serviced after a preset length of time according to an embodiment of the invention. As illustrated, interrupt triggering event “A” may be received, and after a length of time equal to “Y,” as shown on timeline 600, an interrupt may be invoked, and interrupt triggering event “A” may be serviced. Therefore, the interrupt triggering event “A” may be serviced according to the method shown in FIG. 3.

FIG. 6B illustrates multiple interrupt triggering actions being accumulated and serviced after a preset length of time after the first interrupt triggering event occurs according to an embodiment of the invention. As illustrated, interrupt triggering events “A,” “B” and “C” may be received, and after a length of time (starting from when interrupt triggering event “A” is received) equal to “Y,” an interrupt may be invoked, and interrupt triggering events “A,” “B” and “C” may be serviced. Therefore, the interrupt triggering events “A,” “B” and “C” may be serviced according to the method shown in FIG. 3.

FIG. 6C illustrates multiple interrupt triggering actions being accumulated and serviced after a critical interrupt triggering event occurs according to an embodiment of the invention. As illustrated, interrupt triggering events “A,” “B” and “D” may be received, where “D” is a critical interrupt-triggering event. Immediately after critical interrupt triggering event “D” is received, interrupt triggering events “D,” “A” and “B” may be serviced. Interrupt triggering event “E” may then be received, and after after a length of time (starting from when interrupt triggering event “E” is received) equal to “Y,” an interrupt may be invoked, and interrupt triggering event “E” may be serviced. Therefore, the interrupt triggering events “A,” “B,” “D” and “E” may be serviced according to the method shown in FIG. 3. Time “Q” 605 represents the time interval that is “Y” units of time after the first interrupt triggering event (i.e., interrupt trigger event “A”) was received. As shown, an interrupt is not invoked at time “Q” 605. Instead, an interrupt is invoked after the critical interrupt triggering event (i.e., critical interrupt triggering even “D”) occurs, as well as after “Y” units of time after the next interrupt triggering event occurs (i.e., interrupt triggering event “E”). Therefore, whereas methods in the prior art would have invoked the second interrupt at time “Q” 605, the method according to an embodiment of the present invention may invoke the second interrupt at a later time equal to “Y” units of time after interrupt triggering event “E”, a routine interrupt triggering event, was received.

FIG. 6D illustrates multiple interrupt actions being accumulated and serviced after a preset length of time after the last interrupt triggering event occurs. FIG. 6D illustrates the accumulation of interrupt triggering events according to the method shown in FIG. 4. As illustrated, interrupt triggering events “A,” “B, “C”, “E” and “F” may be received, and after a length of time (starting from when the last interrupt triggering event “F” is received) equal to “Y,” an interrupt may be invoked, and interrupt triggering events “A,” “B, “C,” “E” and “F” may be serviced. Therefore, the interrupt triggering events “A,” “B,” “C,” “E” and “F” may be serviced according to the method shown in FIG. 4.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system to accumulate routine and critical interrupt-triggering events, and invoke an interrupt, comprising:
a network to communicate data;
a computing device to execute an operating system;
a Network Interface Card (NIC) to communicate data with the network and with the operating system, and to invoke the interrupt, wherein the NIC accumulates the routine interrupt-triggering events and includes a timer to limit a length of time during which the routine interrupt-triggering events accumulate, and if one of the critical interrupt-triggering events is received or the timer expires, the interrupt is invoked and the timer is reset; and
a driver to provide an interface between the operating system and the NIC.

2. The system of claim 1, wherein the driver sets an interrupt servicing routine to specify how the interrupt is processed.

3. The system of claim 1, wherein the timer is initialized when a first routine interrupt-triggering event is received.

4. The system of claim 1, wherein the timer is initialized when each routine interrupt-triggering event is received.

5. The system of claim 1, wherein the network is a 1 Gigabit Ethernet network.

6. The system of claim 1, wherein the network is a 10 Gigabit Ethernet network.

7. The system of claim 1, wherein the NIC has an interrupt generation logic to specify the routine and critical interrupt-triggering events.

8. The system of claim 1, wherein the operating system is Microsoft Windows or Linux.

9. The system of claim 1, wherein the driver services the interrupt.

10. A method to accumulate routine and critical interrupt-triggering events, and invoke an interrupt, comprising:
executing an operating system;
communicating data with a network and an operating system via a Network Interface Card (NIC);
accumulating the routine interrupt-triggering events; and
limiting a length of time of a timer during which the routine interrupt-triggering events accumulate, wherein when the timer expires or one of the critical interrupt-triggering events is received, the interrupt is invoked and the timer is reset.

11. The method of claim 10, further including setting an interrupt servicing routine to specify how the interrupt is processed.

12. The method of claim 10, further including initializing the timer when a first routine interrupt-triggering event is received.

13. The method of claim 10, further including initializing the timer when each routine interrupt-triggering event is received.

14. The method of claim 10, wherein the network is a 1 Gigabit Ethernet network.

15. The method of claim 10, wherein the network is a 10 Gigabit Ethernet network.

16. The method of claim 10, further including utilizing interrupt generation logic to specify the routine and critical interrupt-triggering events.

17. The method of claim 10, wherein the operating system is Microsoft Windows or Linux.

18. The method of claim 10, further including servicing the interrupt.

19. A machine code storage device, comprising:
a machine-readable medium; and
machine-readable code, stored on the computer-readable medium, having instructions to execute an operating system;
communicate data with a network and with the operating system via a Network Interface Card (NIC); and
accumulate the routine interrupt-triggering events; and
limit a length of time of a timer during which the routine interrupt-triggering events accumulate and when the timer expires or a critical interrupt-triggering event is received, the interrupt is invoked and the timer is reset.

20. The machine code storage device of claim 19, wherein the machine-readable code further includes instructions to set an interrupt servicing routine to specify how the interrupt is processed.

21. The machine code storage device of claim 19, wherein the machine-readable code further includes instructions to initialize the timer when a first routine interrupt-triggering event is received.

22. The machine code storage device of claim 19, wherein the machine-readable code further includes instructions to initialize the timer when each routine interrupt-triggering event is received.

23. The machine code storage device of claim 19, wherein the machine-readable code further includes instructions to utilize interrupt generation logic to specify the routine and critical interrupt-triggering events.

24. The machine code storage device of claim 19, wherein the operating system in Microsoft Windows.

25. A Network Interface Card (NIC) to accumulate routine and critical interrupt-triggering events, and generate an interrupt, comprising:
interrupt generation logic to specify the routine and critical interrupt-triggering events;
an accumulation device to accumulate the routine interrupt-triggering events;
a timer to limit a length of time during which routine interrupt-triggering events accumulate; and
an invocation device to invoke the interrupt when (a) the timer expires or (b) a critical interrupt-triggering event is received, and reset the timer.

26. The NIC of claim 25, further including an interrupt servicing routine to specify how the interrupts are processed.

27. The NIC of claim 25, wherein the timer is initialized when a first routine interrupt-triggering event is received.

28. The NIC of claim 25, wherein the timer is initialized when a each routine interrupt-triggering event is received.

29. The NIC of claim 25, further including an interrupt generation logic to specify the routine and critical interrupt-triggering events.
